(19) United States
(12) Patent Application Publication
(10) Pub. No.: US 2019/0158486 A1
(43) Pub. Date: May 23, 2019

(54) METHOD FOR AUTHORIZATION CODE VERIFICATION AND SERVER

(71) Applicant: JRD COMMUNICATION (SHENZHEN) LTD, SHENZHEN (CN)

(72) Inventor: Chuan Ye, Shenzhen (CN)

(21) Appl. No.: 16/261,563

(22) Filed: Jan. 30, 2019

Related U.S. Application Data
(63) Continuation of application No. PCT/CN2017/092946, filed on Jul. 14, 2017.

(30) Foreign Application Priority Data
Aug. 29, 2016 (CN) 201610754745.6

(51) Int. Cl. H04L 29/06

(52) U.S. Cl. CPC H04L 63/083; H04L 63/102; H04L 67/42

(57) ABSTRACT

The present disclosure provides a method for authorization code verification and a server. The method may include receiving by a server, an authorization code to be verified of a service and receiving identity information of the service, sent from the terminal; determining, whether the identity information satisfies the setting condition. When the identity information satisfies the setting condition, and the authorization code to be verified is determined that the authorization code to be verified is the first authorization code preset by the service or the second authorization code preset by the service, the authorization code to be verified may be passed; or when the identity information does not satisfy the setting condition, and the authorization code to be verified is determined that the authorization code to be verified is only the first authorization code preset by the service, the authorization code to be verified may be passed.

### CROSS-REFERENCE TO RELATED APPLICATIONS

The present application is a continuation-application of International (PCT) Patent Application No. PCT/CN2017/092946, filed on Jul. 14, 2017, which claims foreign priority of Chinese Patent Application No. 201610754745.6, filed on Aug. 29, 2016 in the National Intellectual Property Administration of China, the entire contents of which are hereby incorporated by reference.

### FIELD

The described embodiments relate to a data security technology, and more particularly, to a method for authorization code verification and a server.

### BACKGROUND

Application scenarios of internet become more and more, and the use of various types of accounts and passwords is also to become more and more frequent. In particular, account passwords related to finance and privacy, is required a secure (confirm) authorization password when logging in or paying. The authorization password is usually a string of letters, numbers, and symbols.

When a user inputs a password into a terminal (such as a mobile phone), it is often easy to be seen and be remembered by other person close to the user. The password is easily leaked and is stolen by criminals. In addition, even if the user inputs the password by himself, a criminal may monitor the user's keyboard, mouse, touch screen, and other input devices by a network trojan, and acquire the password input by the user. Once the password is leaked, it may cause huge losses to the user's privacy and property security.

In the related art, it generally adopts a solution that to hide displayed passwords (or displaying passwords as a special symbol such as an *), or to change a number arrangement of the passwords. However, effect of the solution is limited, and the solution still has a risk that password is stolen.

### SUMMARY

The present disclosure provides a method for authorization code verification and a server. It may be possible to provide different authorization code verification according to identity information of a service, to prevent information of a user account from being stolen. Therefore, security of the user account may be improved.

In order to solve the above-mentioned technical problem, a technical solution adopted by the present disclosure is to provide a method for an authorization code verification, including: receiving by a server, an authorization code to be verified of a service, sent from the terminal, and receiving identity information of the service, sent from the terminal; determining, whether the identity information satisfies the setting condition; when the identity information satisfies the setting condition, and the authorization code to be verified is determined that the authorization code to be verified is the first authorization code preset by the service or the second authorization code preset by the service, the authorization code to be verified is passed; or when the identity information does not satisfy the setting condition, and the authorization code to be verified is determined that the authorization code to be verified is only the first authorization code preset by the service, the authorization code to be verified is passed; wherein the identity information includes at least one of identity information of the terminal, identity information of a user, and identity information associated with the service.

In order to solve the above-mentioned technical problem, a technical solution adopted by the present disclosure is to provide an authorization code verification, including: acquiring identity information, and an authorization code to be verified input by a user, when a terminal requests a service; sending the identity information and the authorization code to be verified, to a server; when the server determines that, the identity information satisfies a setting condition, and the authorization code to be verified is a first authorization code preset by the service or a second authorization code preset by the service, the authorization code to be verified is passed; or when the server determines that, the identity information does not satisfy the setting condition, and the authorization code to be verified is only the first authorization code preset by the service, the authorization code to be verified is passed; wherein the identity information includes at least one of identity information of the terminal, identity information of a user, and identity information associated with the service.

In order to solve the above-mentioned technical problem, a technical solution adopted by the present disclosure is to provide a server including a communicating module and a processor, wherein the communicating module is configured to receive an authorization code to be verified of a service, and identity information of the service, sent from the terminal; the processor is configured to perform operations including: determining, whether identity information satisfies a setting condition; when the identity information satisfies the setting condition, and the authorization code to be verified is determined that the authorization code to be verified is a first authorization code preset by the service or a second authorization code preset by the service, an authorization code to be verified is passed; or when the identity information does not satisfy the setting condition, and the authorization code to be verified is determined that the authorization code to be verified is only the first authorization code preset by the service, the authorization code to be verified is passed.

### BRIEF DESCRIPTION OF THE DRAWINGS

FIG. 1 is a flow chart of a method for authorization code verification in accordance with an embodiment in the present disclosure.

FIG. 2 is a flow chart of a method for authorization code verification in accordance with another embodiment in the present disclosure.

FIG. 3 is a flow chart of a method for authorization code verification in accordance with another embodiment in the present disclosure.

FIG. 4 is a structural illustration of a server in accordance with an embodiment in the present disclosure.

FIG. 5 is a structural illustration of a server in accordance with another embodiment in the present disclosure.

FIG. 6 is a structural illustration of a terminal in accordance with an embodiment in the present disclosure.

### DETAILED DESCRIPTION

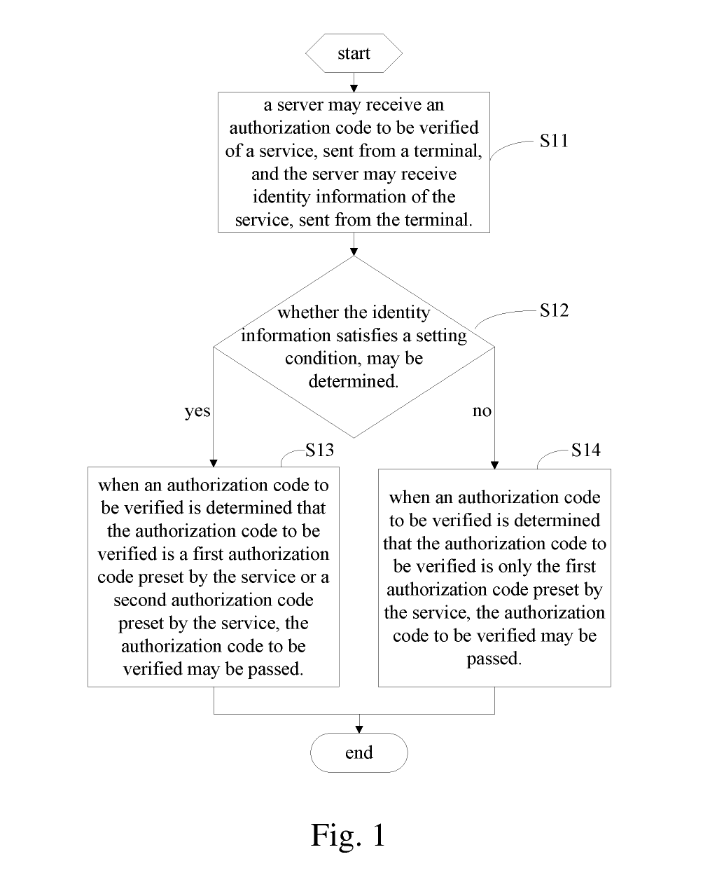

FIG. 1 illustrates a flow chart of a method for authorization code verification in accordance with an embodiment in the present disclosure. The method for the authorization code verification may include operations in the following blocks.

Block S11, a server may receive an authorization code to be verified of a service, sent from a terminal, and the server may receive identity information of the service, sent from the terminal.

The service may be an authorization service requested by a user through the terminal, and may include account login, modification of user information, password or other privacy operations, financial operations such as payment or transfer, and transaction operations of virtual items in the network.

The authorization code to be verified of the service, may be an authorization code input by the user and received by the terminal. The authorization code may be a character string or a gesture symbol input by the user through a keyboard, a mouse, a touch screen, or the like, or the authorization code may be a sound signal input through a voice receiver.

The identity information of the service may include at least one of identity information of the terminal, identity information of a user, and identity information associated with the service.

The identity information of the terminal may be a terminal type, and, a network IP address, etc. When the terminal is a mobile phone, the identity information of the terminal may also be a mobile phone serial number, user information associated with a subscriber identity module (SIM, i.e., the mobile phone number) card in the mobile phone, and the like. The identity information of a user may be identity information input by the user, identity information verified by password protection questions input by the user, and the like; or the identity information of a user may be identity information determined by recoding body identification such as fingerprint, voices and the like. The identity information associated with the service may be identity information that the user needs to authorize when the user registers. For example, when a user logs in to an account, the identity information associated with the service is identity information of the user to which the account belongs.

In at least one embodiment, the identity information of the service may also include a combination of two or three of the identity information of the terminal, the identity information of a user, and the identity information associated with the service.

For example, the identity information of the service may be information matched to the identity information associated with the service and the identity information of the terminal.

Block S12: whether the identity information satisfies a setting condition, may be determined.

The setting condition may be set according to different requirements.

Take a login account as an example. The setting condition may be an IP address of the login account. After the terminal acquires an account and a password input by a user, the account, the password, and an IP address in network of the terminal may be sent to a server. The server may determine whether the IP address is a frequently used IP address that the account logs in.

Take a login account as an example, the setting condition may also be a mobile phone number. After the terminal acquires an account and a password input by a user, the account, the password, and a mobile phone number of in the terminal may be sent to a server. The server may determine whether the mobile phone number is a frequently used mobile phone number that the account logs in.

When a result of the determination in block S12 is yes, an operation in S13 may be performed. When the result of the determination in block S12 is no, an operation in S14 may be performed.

Block S13, when an authorization code to be verified is determined that the authorization code to be verified is a first authorization code preset by the service or a second authorization code preset by the service, the authorization code to be verified may be passed.

That is, when the identity information satisfies the setting condition, whether the authorization code to be verified input by the user is the first authorization code preset by the service or the second authorization code preset by the service, the authorization code to be verified may be passed.

Block S14, when an authorization code to be verified is determined that the authorization code to be verified is only the first authorization code preset by the service, the authorization code to be verified may be passed.

That is, when the identity information does not satisfy the setting condition, only when the authorization code to be verified input by the user is the first authorization code preset by the service, the authorization code to be verified may be passed; when the authorization code to be verified input by the user is the second authorization code preset by the service, the authorization code to be verified may not be passed.

It should be noted that, the first authorization code and the second authorization code preset by the service may be preset by a user. In other embodiments, the method may include operations as the following descriptions.

The server may receive a user setting sent from a terminal. The user setting may include the setting condition of the identity information of the service, the first authorization code, and the second authorization code. The user setting may further include operations that the user setting is checked and saved.

The setting condition of the identity information may be preset identity information. Thereby, the operation in block S12 may specifically be that, whether the identity information satisfies the setting condition, may be determined.

For example, when identity information preset by an account is set to a mobile phone number A, it may be determined whether the mobile phone number that a user logs into the account satisfies the mobile phone number A, during the operation in block S12.

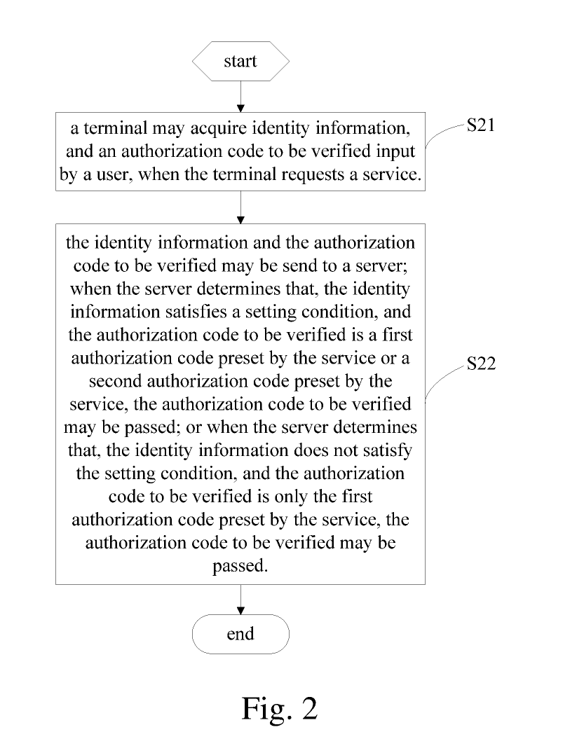

FIG. 2 illustrates a flow chart of a method for authorization code verification in accordance with another embodiment in the present disclosure. The method for authorization code verification may include operations in the following blocks.

Block S21, a terminal may acquire identity information, and an authorization code to be verified input by a user, when the terminal requests a service.

The identity information may include at least one of identity information of the terminal, identity information of a user, and identity information associated with the service.

In at least one embodiment, the identity information of the service may also include a combination of two or three of the identity information of the terminal, the identity information of a user, and the identity information associated with the service.

Block S22, the identity information and the authorization code to be verified may be send to a server; when the server determines that, the identity information satisfies a setting condition, and the authorization code to be verified is a first authorization code preset by the service or a second authorization code preset by the service, the authorization code to be verified may be passed; or when the server determines that, the identity information does not satisfy the setting condition, and the authorization code to be verified is only the first authorization code preset by the service, the authorization code to be verified may be passed.

In at least one embodiment, before the block S12, the method may further include operations in the following descriptions.

A user setting including the setting condition of the identity information, the first authorization code, and the second authorization code, may be received. After the user setting is encrypted by an asymmetric encryption algorithm, the user setting may be sent to the server, to check and save the user setting by the server.

In should be noted that, the above-mentioned operations may be only performed in an initial setup or when the identity information needs to be modified, it may not be performed each time.

This embodiment is based on the above-mentioned embodiment. The method performed by the terminal corresponding to the server may be similar in principles in the above-mentioned embodiment, therefore no additional description is given herein.

A specific example may be described the above-mentioned two embodiments as the following descriptions.

When a user registers an account, a first authorization code, a second authorization code, and identity information (including at least the user's mobile phone number) associated with the account may be set. The first authorization code may be a more complex real password. The second authorization code may be a relatively simple password instead of the first authorization code. For example, the first authorization code must be a password including a combination of uppercase and lowercase letters with numbers, and the second authorization code may be a purely numeric password such as 123456.

When the user logs by a mobile phone A, the user may input the account and the relatively simple second authorization code. The mobile phone A may send the account, the password, and a mobile phone number of the mobile phone A to the server. When the server verifies the identity information, and the mobile phone number is determined to be the mobile phone number that the account registered, a login environment of the account may be determined to be secure, and the second authorization code to be verified may be passed.

When a criminal acquires the account and the second authorization code by a certain means when the user logs in, and the criminal logs by a mobile phone B, the mobile phone B may send the account, the password, and a mobile phone number of the mobile phone B to the server. When the server verifies the identity information, and the mobile phone number is not determined to be the mobile phone number that the account registered, a login environment of the account may be not determined to be secure, and the second authorization code to be verified may not be passed.

In addition, when a user needs to log in to an account by other devices, the first authorization code may be input. When the server verifies the identity information, the first authorization code may be passed, regardless of a terminal in any environment.

As compared with the related art, the present disclosure may provide an authorization code verification, including: acquiring identity information, and an authorization code to be verified input by a user, when a terminal requests a service; when the server determines that, the identity information satisfies a setting condition, and the authorization code to be verified is a first authorization code preset by the service or a second authorization code preset by the service, the authorization code to be verified is passed; or when the server determines that, the identity information does not satisfy the setting condition, and the authorization code to be verified is only the first authorization code preset by the service, the authorization code to be verified is passed. An authorization code of identity information of a service may be verified by different authorization code verifications according different services, to prevent user account information from being stolen and improve the security of user accounts.

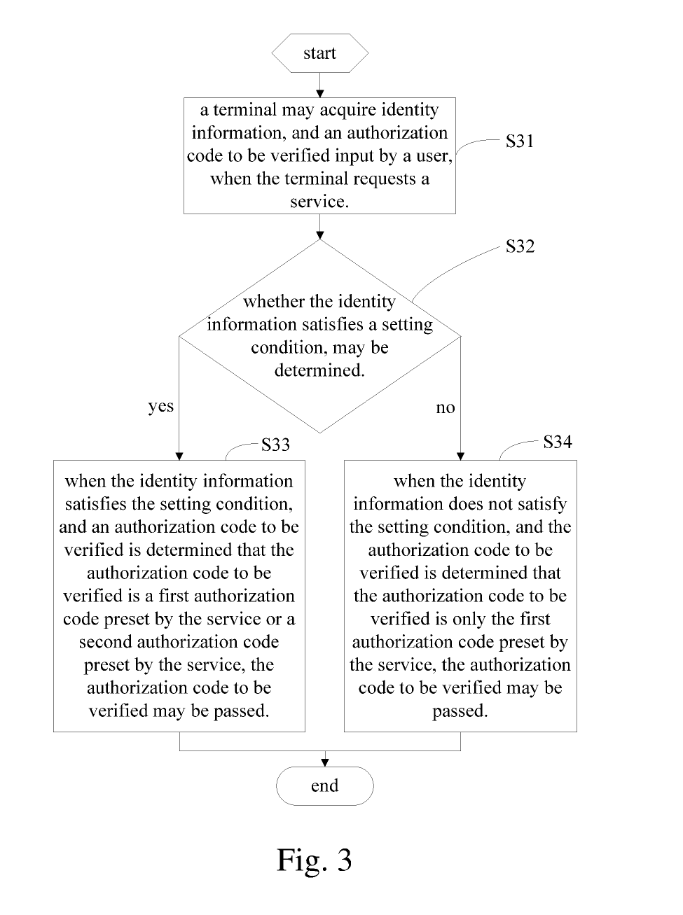

FIG. 3 illustrates a flow chart of a method for authorization code verification in accordance with another embodiment in the present disclosure. The method for authorization code verification may include operations in the following blocks.

Block S31, a terminal may acquire identity information, and an authorization code to be verified input by a user, when the terminal requests a service.

Block S32, whether the identity information satisfies a setting condition, may be determined.

Block S33, when the identity information satisfies the setting condition, and an authorization code to be verified is determined that the authorization code to be verified is a first authorization code preset by the service or a second authorization code preset by the service, the authorization code to be verified may be passed.

Block S34, when the identity information does not satisfy the setting condition, and the authorization code to be verified is determined that the authorization code to be verified is only the first authorization code preset by the service, the authorization code to be verified may be passed.

Different from the above-mentioned two embodiments, all operations of this embodiment may be completed in a terminal. It may be a method for authorization code verification without requiring operations in network, and may be configured to unlock a mobile phone, a password for a stand-alone application, and the like.

For example, a user may set a first unlock password and a second unlock password in advance, and may set a setting condition. The setting condition may be that whether an unlocked location is located in a specific range (e.g., the user's home, company, or other places that the user frequently located in).

When a user is located in a specific location, a mobile phone may be unlocked by regardless of whether the first unlocking password or the second unlocking password is used. When the mobile phone is not unlocked in the specific location because the user's mobile phone is stolen or other situations, only the first unlocking password may be used to unlock.

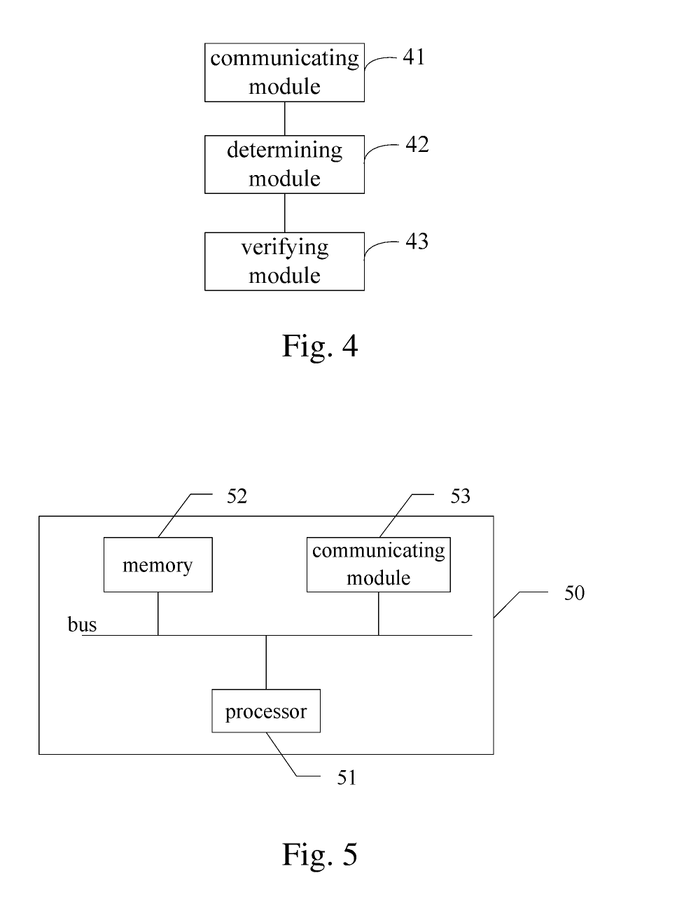

FIG. 4 illustrates a structural illustration of a server in accordance with an embodiment in the present disclosure. The server may include a communicating module 41, a determining module 42, and a verifying module 43. The communicating module 41 may be configured to receive an authorization code to be verified of a service, and identity information of the service. The determining module 42 may be configured to determine whether the identity information satisfies the setting condition. The verifying module 43 may be configured to pass the authorization code to be verified, when the identity information satisfies the setting condition, and the authorization code to be verified is a first authorization code preset by the service or a second authorization code preset by the service.

The verifying module 43 may be further configured to pass the authorization code to be verified, when the identity information does not satisfy the setting condition, and the authorization code to be verified is only the first authorization code preset by the service.

FIG. 5 illustrates a structural illustration of a server in accordance with another embodiment in the present disclosure. The server may include a processor 51, a memory 52, and a communicating module 53.

In at least one embodiment, the processor 51, the memory 52, and the communicating module 53 may be coupled by a bus.

The memory 52 may be configured to store system files, application software, and preset identity information, authorization codes, and the like.

The communicating module 53 may be configured to receive an authorization code to be verified of a service, and identity information of the service, sent from the terminal.

The processor 51 may be configured to perform operations as the following descriptions.

The processor may determine whether identity information satisfies a setting condition. When the identity information satisfies the setting condition, and the authorization code to be verified is determined that the authorization code to be verified is a first authorization code preset by the service or a second authorization code preset by the service, an authorization code to be verified may be passed; or when the identity information does not satisfy the setting condition, and the authorization code to be verified is determined that the authorization code to be verified is only the first authorization code preset by the service, the authorization code to be verified may be passed.

In at least one embodiment, the identity information may include at least one of identity information of the terminal, identity information of a user, and identity information associated with the service.

In at least one embodiment, the communicating module 53 may be further configured to receive the authorization code to be verified of the service, and the identity information of the service. The processor 51 may be further configured to verify the user setting, and the memory 52 may be further configured to save the user setting.

In the several above-mentioned embodiments provided by the present disclosure, it should be noted that the disclosed method and apparatus may be implemented in other manners. For example, devices of the above-mentioned embodiments are merely illustrative. For example, the division of the modules or units is only a logical function division. In actual implementation, there may be another division manner, for example, multiple units or components may be used, combined or may be integrated into another system, or some features may be ignored or not executed.

The units described as separate components may or may not be physically separated, and the components displayed as units may or may not be physical units, that is, may be located in one place, or may be distributed to multiple network units. Some or all of the units may be selected according to actual needs to achieve the objectives of the embodiments of the present embodiment.

In addition, each functional unit in each embodiment of the present disclosure may be integrated into one processing unit, or each unit may exist physically separately, or two or more units may be integrated into one unit. The above integrated unit may be implemented in the form of hardware or in the form of a software functional unit.

The integrated units of the other embodiments described above, if implemented in the form of software functional units and sold or used as separate products, may be stored in a computer readable storage medium. Based on such understanding, the technical solution of the present disclosure, which is essential or contributes to the related art, or all or part of the technical solution, may be implemented in the form of a software product stored in a storage medium. The computer software product may be stored in a storage medium and may include instructions for causing a computer device (which may be a personal computer, a server, or a network device, etc.) or a processor to perform all or part of the operations in the methods of various embodiments of the present disclosure. The above-mentioned storage medium may include a flash drive, a mobile hard disk, a read-only memory (ROM), a random access memory (RAM), a magnetic disk, or an optical disk, and the like, which may store program codes.

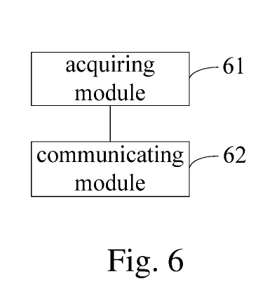

FIG. 6 illustrates a structural illustration of a terminal in accordance with an embodiment in the present disclosure. The server may include an acquiring module 61 and a communicating module 62. The acquiring module may be configured to acquire identity information, and an authorization code to be verified input by a user, when a terminal requests a service. The communicating module may be configured to send the identity information and the authorization code to be verified, to a server. When the server determines that, the identity information satisfies a setting condition, and the authorization code to be verified is a first authorization code preset by the service or a second authorization code preset by the service, the authorization code to be verified may be passed; or when the server determines that, the identity information does not satisfy the setting condition, and the authorization code to be verified is only the first authorization code preset by the service, the authorization code to be verified may be passed.

It should be noted that, the server and the terminal in this embodiment may be both a server and a terminal based on a method for an authorization code verification in the above-mentioned embodiment. Principles and operations in this embodiment may be similar to the above-mentioned embodiment, therefore no additional description is given herein.

It is understood that the descriptions above are only embodiments of the present disclosure. It is not intended to limit the scope of the present disclosure. Any equivalent transformation in structure and/or in scheme referring to the instruction and the accompanying drawings of the present disclosure, and direct or indirect application in other related technical field, are included within the scope of the present disclosure.

What is claimed is:

1. A method for an authorization code verification, comprising:
receiving a user setting by a server, sent from a terminal, wherein the user setting comprise a setting condition of identity information, a first authorization code, and a second authorization code;
checking and saving the user setting;
receiving an authorization code to be verified of a service, sent from the terminal, and receiving identity information of the service, sent from the terminal;
determining, whether the identity information satisfies the setting condition;
when the identity information satisfies the setting condition, and the authorization code to be verified is determined that the authorization code to be verified is the first authorization code preset by the service or the second authorization code preset by the service, the authorization code to be verified is passed; or
when the identity information does not satisfy the setting condition, and the authorization code to be verified is determined that the authorization code to be verified is only the first authorization code preset by the service, the authorization code to be verified is passed;
wherein the identity information comprises at least one of identity information of the terminal, identity information of a user, and identity information associated with the service.

2. The method according to claim 1, further comprising:
when the identity information is initialized or modified, receiving the user setting by the server, sent from the terminal.

3. The method according to claim 1, wherein
the first authorization code is a password;
the second authorization code is a password;
the first authorization code is more complex than the second authorization code.

4. The method according to claim 1, wherein
the setting condition of the identity information is a preset identity information;
the determining, whether the identity information satisfying the setting condition, comprises:
determining, whether the identity information matches the preset identity information.

5. The method according to claim 1, wherein
the terminal is a mobile phone, and the identity information of the terminal is a mobile phone number of the mobile phone.

6. A method for an authorization code verification, comprising:
acquiring identity information, and an authorization code to be verified input by a user, when a terminal requests a service;
sending the identity information and the authorization code to be verified, to a server;
when the server determines that, the identity information satisfies a setting condition, and the authorization code to be verified is a first authorization code preset by the service or a second authorization code preset by the service, the authorization code to be verified is passed; or
when the server determines that, the identity information does not satisfy the setting condition, and the authorization code to be verified is only the first authorization code preset by the service, the authorization code to be verified is passed.

7. The method according to claim 6, wherein
the first authorization code is a password;
the second authorization code is a password;
the first authorization code is more complex than the second authorization code.

8. The method according to claim 6, wherein
the identity information comprises at least one of identity information of the terminal, identity information of a user, and identity information associated with the service.

9. The method according to claim 8, wherein
the terminal is a mobile phone, and the identity information of the terminal is a mobile phone number of the mobile phone.

10. The method according to claim 6, further comprising
receiving a user setting comprising the setting condition of the identity information, the first authorization code, and the second authorization code;
after the user setting is encrypted by an asymmetric encryption algorithm, sending the user setting to the server, to check and save the user setting by the server.

11. The method according to claim 10, wherein
when the user setting is initialized or modified, receiving the user setting by the server.

12. The method according to claim 10, wherein
the setting condition of the identity information is a preset identity information;
determining by the server, whether the identity information satisfies the setting condition, comprises:
determining by the server, whether the identity information matches the preset identity information.

13. A server comprising a communicating device and a processor, wherein
the communicating device is configured to receive an authorization code to be verified of a service, and identity information of the service, sent from the terminal;
the processor is configured to perform operations comprising:
determining, whether identity information satisfies a setting condition;
when the identity information satisfies the setting condition, and the authorization code to be verified is determined that the authorization code to be verified is a first authorization code preset by the service or a second authorization code preset by the service, an authorization code to be verified is passed; or
when the identity information does not satisfy the setting condition, and the authorization code to be verified is determined that the authorization code to be verified is only the first authorization code preset by the service, the authorization code to be verified is passed.

14. The server according to claim 13, wherein
the first authorization code is a password;
the second authorization code is a password;
the first authorization code is more complex than the second authorization code.

15. The server according to claim 13, further comprising a memory, wherein
the communicating device is further configured to receive the authorization code to be verified of the service, and the identity information of the service;
the processor is configured to verify a user setting;
the memory is configured to save the user setting.

16. The server according to claim 13, wherein
when the user setting is initialized or modified, receiving the user setting by the server.

17. The server according to claim 13, wherein
the server further comprises a bus;
the bus is configured to couple the communicating device, the processor, and the memory.

18. The server according to claim 15, wherein
the setting condition of the identity information is a preset identity information;
the processor is further configured to determine whether the identity information matches the preset identity information.

19. The server according to claim 13, wherein
the identity information comprises at least one of identity information of the terminal, identity information of a user, and identity information associated with the service.

20. The server according to claim 19, wherein
the terminal is a mobile phone, and the identity information of the terminal is a mobile phone number of the mobile phone.
